(19) United States
(12) Patent Application Publication
(10) Pub. No.: US 2018/0304111 A1
(43) Pub. Date: Oct. 25, 2018

(54) Sprinkler Head

(71) Applicants: SENJU SPRINKLER CO., LTD., Tokyo (JP); NOHMI BOSAI LTD., Tokyo (JP)

(72) Inventors: Yukinori Karihara, Tokyo (JP); Masakatsu Kikuchi, Tokyo (JP); Takumi Ishikawa, Tokyo (JP); Masashi Murakami, Tokyo (JP)

(73) Assignees: SENJU SPRINKLER CO., LTD., Tokyo (JP); NOHMI BOSAI LTD., Tokyo (JP)

(21) Appl. No.: 15/927,155

(22) Filed: Mar. 21, 2018

(30) Foreign Application Priority Data
Mar. 30, 2017 (JP) 2017-066881

(51) Int. Cl. A62C 37/12; A62C 35/68; B05B 1/26

(52) U.S. Cl. CPC A62C 37/12; B05B 1/267; A62C 35/68

(57) ABSTRACT

A sprinkler head employing balls for a heat-sensitive disassembling unit is provided, in which the time period from when a fusible alloy starts to melt until when the sprinkler head is activated is shortened. A sprinkler head includes a frame having a stepped portion projecting inward. The stepped portion has an upper inclined surface provided at the inner-peripheral upper edge thereof and with which balls come into contact, and a guide part provided at the inner-peripheral lower edge thereof and that allows any of the balls that is displaced from the upper inclined surface to move downward from the stepped portion. When a fusible alloy melts, the ball displaced from the upper inclined surface moves along the guide part and is quickly released to the outside of the frame. Hence, the time period from when the fusible alloy starts to melt until when the sprinkler head is activated is shortened.

### BACKGROUND OF THE INVENTION

### 1. Field of the Invention

The present invention relates to a fire-extinguishing sprinkler head.

### 2. Description of the Related Art

A sprinkler head sprinkles water by being activated automatically in case of a fire and includes a nozzle connected to a water-supply pipe and a heat-sensitive disassembling unit that is activated with the heat of the fire. In normal times, the outlet of the nozzle is closed by a valve member, to which a load is applied from the heat-sensitive disassembling unit so that the outlet of the nozzle is closed. A snapping member, such as a disc spring, is provided between the valve member and the heat-sensitive disassembling unit, whereby the valve member is pressed in such a direction as to close the outlet of the nozzle.

Examples of such a sprinkler head include those employing balls or rings for the heat-sensitive disassembling unit (see Japanese Unexamined Patent Application Publication No. 2012-105952, for example). In such a sprinkler head, the length of travel of each of components that are necessary for sprinkling water at the activation of the sprinkler head is set to a large value. Therefore, the load for closing the nozzle is less likely to be reduced even if, for example, an external force is applied to the sprinkler head in normal times. That is, the sprinkler head has excellent shock resistance.

If any external force is applied to the sprinkler head according to Japanese Unexamined Patent Application Publication No. 2012-105952, the balls or other relevant components may be displaced slightly. However, such displacements are each smaller than the length of travel set forth for activating the sprinkler head to sprinkle water and do not activate the sprinkler head. In contrast, if a fire occurs and melts a fusible alloy, any of the balls start to move. Then, before the heat-sensitive disassembling unit is disassembled and falls off, a plurality of balls fall off a stepped portion of a frame, whereby the heat-sensitive disassembling unit that has been supported loses its balance. Hence, the heat-sensitive disassembling unit cannot be held at the stepped portion of the frame anymore. Consequently, the heat-sensitive disassembling unit falls off, and the valve member opens the outlet of the nozzle. Thus, the sprinkler head is activated.

More specifically, referring to FIGS. 10 to 12, a sprinkler head 100 according to Japanese Unexamined Patent Application Publication No. 2012-105952 includes eight balls 82 provided between a frame F and a heat-sensitive disassembling unit T. The sprinkler head 100 is activated as follows: any of the balls 82 are displaced from a stepped portion 80 of the frame F, go over an inner peripheral surface 80A of the stepped portion 80, and are released to the outside from the lower end of the frame F. Since the balls 82 are displaced and move away from the stepped portion 80, the heat-sensitive disassembling unit T cannot stay engaged with the frame F anymore and falls off. Simultaneously, a snapping member 83 and a valve member that have been supported by the heat-sensitive disassembling unit T also fall off, whereby a nozzle is opened.

Referring to FIG. 11, when the balls 82 are displaced from the stepped portion 80 and are released to the outside of the frame F, a frictional resistance occurs between the inner peripheral surface 80A of the stepped portion 80 and each of the balls 82. This frictional resistance is one of causes that prevent the smooth movement of the balls 82.

Referring to FIG. 12, the eight balls 82 are provided between the stepped portion 80 of the frame F and the peripheral edge of a slider 81 and are arranged at regular intervals. A virtual straight line L passes through a first ball 82A and the center of the slider 81. A second ball 82B is positioned on the extension of the virtual straight line L. On the virtual straight line L, a central portion of the upper surface of the slider 81 is urged downward by the snapping member 83, while the peripheral edge of the lower surface of the slider 81 is supported by the two balls 82A and 82B, whereby the slider 81 is balanced.

As illustrated in FIG. 12, the first ball 82A and the second ball 82B are provided opposite each other on the virtual straight line L along which the slider 81 is supported. The slider 81 holds the eight balls 82 that are arranged at regular intervals. Accordingly, there are three other virtual straight lines L similar to the above virtual straight line L. Thus, the slider 81 are held stable. Hence, even if a fusible alloy 84 melts and one of the two balls 82 serving as the supports provided on one of the virtual straight lines L falls off (see FIG. 11), the slider 81 is kept supported stably by the remaining ones of the balls 82. Therefore, unless any of the balls 82 provided on the other virtual straight lines L fall off, the slider 81 does not fall off. Accordingly, in the case of the sprinkler head 100 configured as above, it takes a little time from when the fusible alloy 84 starts to melt until the sprinkler head 100 is activated, compared with a case of a sprinkler head including a lever-type heat-sensitive disassembling unit (see Japanese Unexamined Patent Application Publication No. 7-284545, for example).

### SUMMARY OF THE INVENTION

The present invention has been conceived in view of the above technical background. An object of the present invention is to provide a sprinkler head employing balls for a heat-sensitive disassembling unit and to shorten the time period from when a fusible alloy starts to melt until when the sprinkler head is activated.

To achieve the above object, the present invention provides the following sprinkler head.

According to the present invention, a sprinkler head includes a body having a nozzle; a valve member that closes an outlet of the nozzle; a tubular frame whose one end is connected to the body and the other end has a stepped portion projecting inward; and a heat-sensitive disassembling unit including a plurality of balls locked at the stepped portion, the heat-sensitive disassembling unit being disassembled and activated when a fusible alloy melts. The stepped portion includes a contact part provided at an inner-peripheral upper edge of the stepped portion and with which the balls are in contact; and a guide part provided by cutting off an inner-peripheral lower edge of the stepped portion, the guide part allowing any of the balls that is displaced from the contact part to move downward from the stepped portion.

In the above configuration, the ball displaced from the contact part can move along the guide part that is provided by cutting off the inner-peripheral lower edge of the stepped portion, and the ball can be released quickly to the outside of the frame. Hence, the time period from when the fusible alloy starts to melt until when the sprinkler head is activated can be shortened.

The contact part may be an upper inclined surface provided at the inner-peripheral upper edge. In such a configuration, in normal times, the spherical surface of each of the balls can be held stably by the upper inclined surface of the stepped portion. Furthermore, when the fusible alloy starts to melt, the balls roll along the upper inclined surface. Therefore, the balls can be guided quickly to the guide part.

The guide part may have a lower inclined surface provided at the inner-peripheral lower edge. Moreover, the guide part may include an inner-peripheral stepped part provided at the inner-peripheral lower edge. With such a guide part, any of the balls that is displaced from the contact part can be guided quickly to the outside of the frame.

The stepped portion may include a vertical part provided between the contact part and the guide part and whose length in a direction in which a center axis of the frame extends is shorter than a thickness of the stepped portion. In such a configuration, any of the balls that is displaced from the contact part can be guided to the guide part along the vertical part. Moreover, since the length of the vertical part in the direction in which the center axis of the frame extends is shorter than the thickness of the stepped portion, the ball can be moved quickly to the guide part.

The heat-sensitive disassembling unit may include a balancer provided between the fusible alloy and the balls, and the balancer may have a contact recess at an outer periphery, the contact recess being in contact with the stepped portion of the frame. In such a configuration, the balls are in contact with both the contact part of the stepped portion of the frame and the contact recess provided in the balancer included in the heat-sensitive disassembling unit. Hence, the balls can be supported stably in normal times.

The heat-sensitive disassembling unit may include a slider that retains the balls at respective predetermined positions of the stepped portion, and the balls may each be retained on a corresponding one of different virtual straight lines each passing through a center of the slider and an outer peripheral edge of the slider. Furthermore, the slider may have retaining recesses at the outer peripheral edge, the retaining recesses receiving the balls, respectively.

In such a configuration, since only one ball is provided on each of the virtual straight lines, the slider easily loses its balance if one of the balls falls off the slider with the melting of the fusible alloy. Hence, the remaining ones of the balls are urged to move, and the time taken for the heat-sensitive disassembling unit to fall off can be shortened. Thus, the time period from when the fusible alloy starts to melt until when the sprinkler head is activated can be made shorter than in the case of the related-art example employing the balls. Moreover, since the slider has the retaining recesses, the balls can be easily set at the predetermined positions, respectively, with no position errors.

In the sprinkler head according to the present invention, the balls may be provided in an odd number and be arranged at regular intervals. In such a case, the retaining recesses provided at the outer peripheral edge of the slider and receiving the respective balls may also be provided in an odd number and be arranged at regular intervals on one virtual circular line. In such a configuration, the load for closing the nozzle with the valve member can be distributed evenly among all of the balls, and the state where the nozzle is closed by the valve member can be maintained stably.

According to the present invention, the sprinkler head employing balls for the heat-sensitive disassembling unit includes the guide part at the lower edge of a projection provided at the stepped portion of the frame, and the guide part allows any of the balls that is displaced from the contact part of the stepped portion to move downward from the stepped portion. Hence, the time period from when the fusible alloy starts to melt until when the sprinkler head is activated can be shortened.

### BRIEF DESCRIPTION OF THE DRAWINGS

FIG. 1 is a sectional view of a sprinkler head according to an embodiment of the present invention;

FIG. 2 is an enlarged sectional view of a part of FIG. 1, including a stepped portion of a frame;

FIG. 3 is a perspective view of a sprinkling unit;

FIGS. 4A, 4B, and 4C are a plan view, a perspective view, and a sectional view taken along line IVC-IVC illustrated in FIG. 4A, respectively, of a snapping member illustrated in FIG. 1;

FIG. 5 is a sectional view of the sprinkler head that is taken along line V-V illustrated in FIG. 1;

FIG. 6 is an enlarged sectional view of a part of FIG. 1, including a cylinder;

FIGS. 7A to 7D are sectional views of the sprinkler head illustrated in FIG. 1 and illustrate a process in which the sprinkler head is activated;

FIG. 8 is an enlarged sectional view of a part corresponding to the part illustrated in FIG. 2, including a stepped portion according to a first modification;

FIG. 9 is an enlarged sectional view of a part corresponding to the part illustrated in FIG. 2, including a stepped portion according to a second modification;

FIG. 10 is a sectional view of a sprinkler head according to a related-art example;

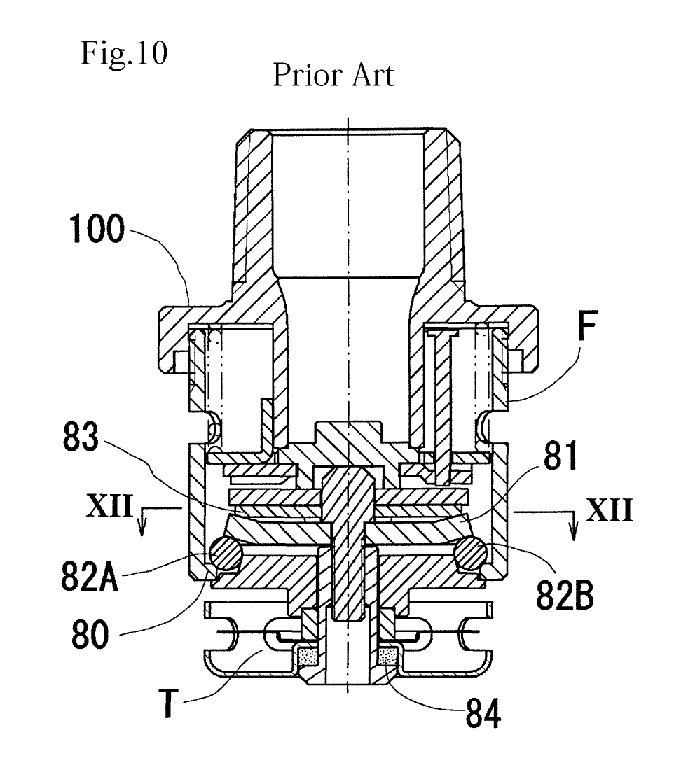

FIG. 11 is a sectional view of the sprinkler head illustrated in FIG. 10 and illustrates a process in which the sprinkler head is activated; and

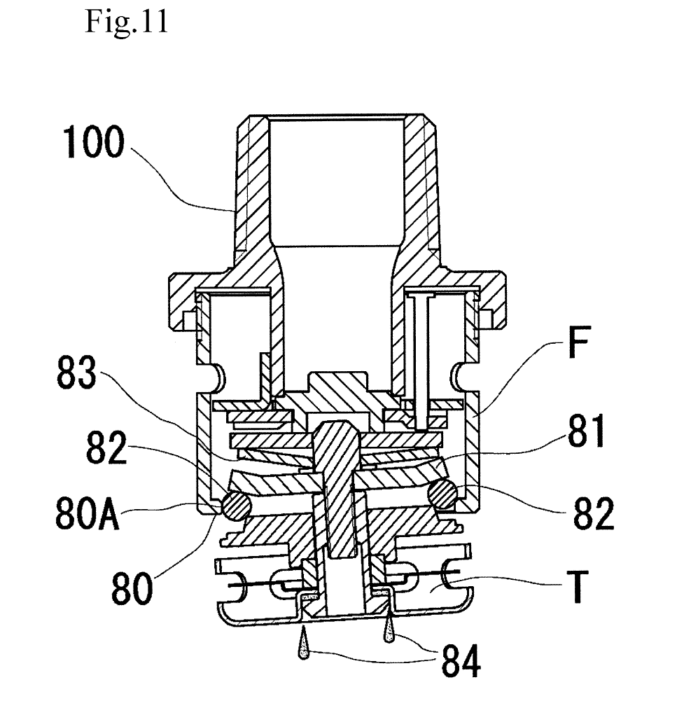

FIG. 12 is a sectional view of the sprinkler head that is taken along line XII-XII illustrated in FIG. 10.

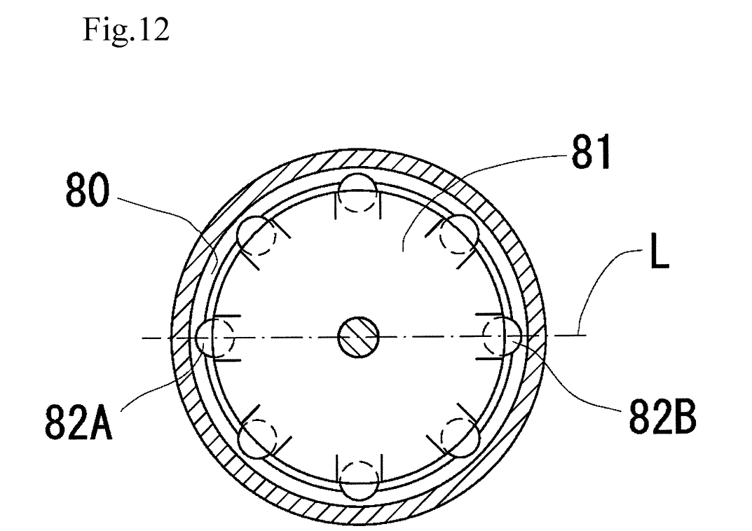

### DESCRIPTION OF THE PREFERRED EMBODIMENTS

A sprinkler head according to an embodiment of the present invention will now be described with reference to the accompanying drawings. A sprinkler head S according to the embodiment includes a body 1, a frame 2, a valve member 3, a sprinkling unit 4, a snapping member 5, and a heat-sensitive disassembling unit 6.

The body 1 has a cylindrical shape, in which a nozzle 11 is provided. The body 1 includes a screw portion 12 at the upper end thereof. The screw portion 12 is threaded on the outer peripheral surface thereof and is connected to a water-supply pipe (not illustrated). The nozzle 11 extends on the inner side of the screw portion 12 and has a nozzle end 11a, corresponding to the outlet of the nozzle 11, at the lower end thereof. The nozzle end 11a is in contact with the valve member 3 and is thus closed by the valve member 3 in normal times. The body 1 further includes a flange portion 1a provided at a middle part thereof and projecting from the outer periphery thereof. The flange portion 1a is provided with a screw portion 13 at the inner peripheral edge thereof. The body 1 is connected to the frame 2 at the screw portion 13.

The frame 2 has a cylindrical shape and includes a screw portion 21 at the upper end thereof. The screw portion 21 serves as a connector connected to the body 1 and is in mesh with the screw portion 13 of the body 1. The frame 2 further includes an annular stepped portion 22 at the lower end thereof. The stepped portion 22 projects inward from the inner periphery of the frame 2. Balls 61 to be described below are locked at the stepped portion 22.

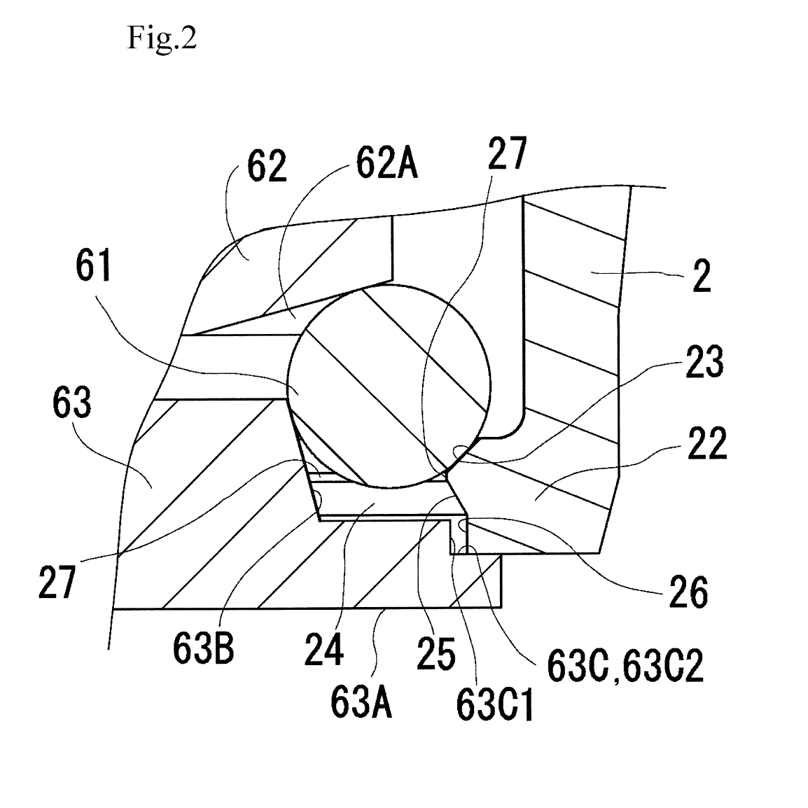

Referring to FIG. 2, the stepped portion 22 has an upper inclined surface 23 serving as a “contact part” with which the balls 61 are in contact in normal times. The upper inclined surface 23 is provided by cutting off the inner-peripheral upper edge of the stepped portion 22 and forms an upward inclined surface connecting the inner peripheral surface of the stepped portion 22 and the upper surface of the stepped portion 22.

The stepped portion 22 includes a vertical part 27. The vertical part 27 that is continuous with the lower end of the upper inclined surface 23. The length of the vertical part 27 in the direction in which the center axis of the frame 2 extends (the direction is hereinafter referred to as “the axial direction of the frame 2”) is shorter than a length corresponding to the thickness of the stepped portion 22. The vertical part 27 has a function of guiding the balls 61 displaced from the upper inclined surface 23 to a guide part 24 to be described below. Since the length of the vertical part 27 in the axial direction of the frame 2 is shorter than the thickness of the stepped portion 22 in the axial direction of the frame 2, the balls 61 are quickly guided to the guide part 24.

As illustrated in FIG. 2, the stepped portion 22 includes the guide part 24 that is continuous with the lower end of the vertical part 27. The guide part 24 has a function of accelerating the release of the balls 61 from the inside of the frame 2 at the activation of the sprinkler head S. The guide part 24 has a lower inclined surface 25 forming a downward inclined surface connecting the lower end of the vertical part 27 and the bottom surface of the stepped portion 22. Since the lower inclined surface 25 is continuous with the vertical part 27, the balls 61 displaced from the upper inclined surface 23 and guided along the vertical part 27 move toward the lower inclined surface 25, which is provided by cutting off the inner-peripheral lower edge of the stepped portion 22.

The stepped portion 22 further includes a straight part 26 on the lower side of the lower inclined surface 25. The straight part 26 is a part that comes into contact with a balancer 63. The straight part 26 faces an outer peripheral surface 63C1 of a contact recess 63C provided annularly along the outer periphery of a collar portion 63A of the balancer 63, with a gap interposed therebetween. An end surface of the straight part 26 (the bottom surface of the stepped portion 22) is in contact with a bottom surface 63C2 of the contact recess 63C. In such a configuration, even if an external force is applied to the sprinkler head S, the external force is absorbed because the balancer 63 is allowed to move until the outer peripheral surface 63C1 of the contact recess 63C comes into contact with the straight part 26. Thus, relevant components are prevented from being displaced or damaged, and the shock resistance of the sprinkler head S is enhanced.

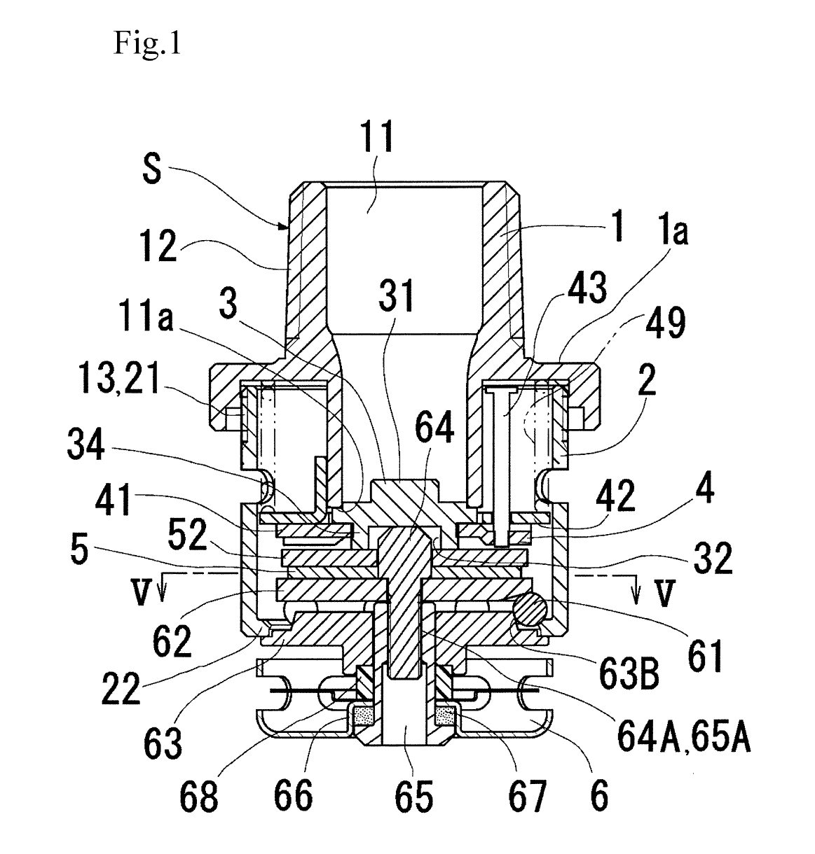

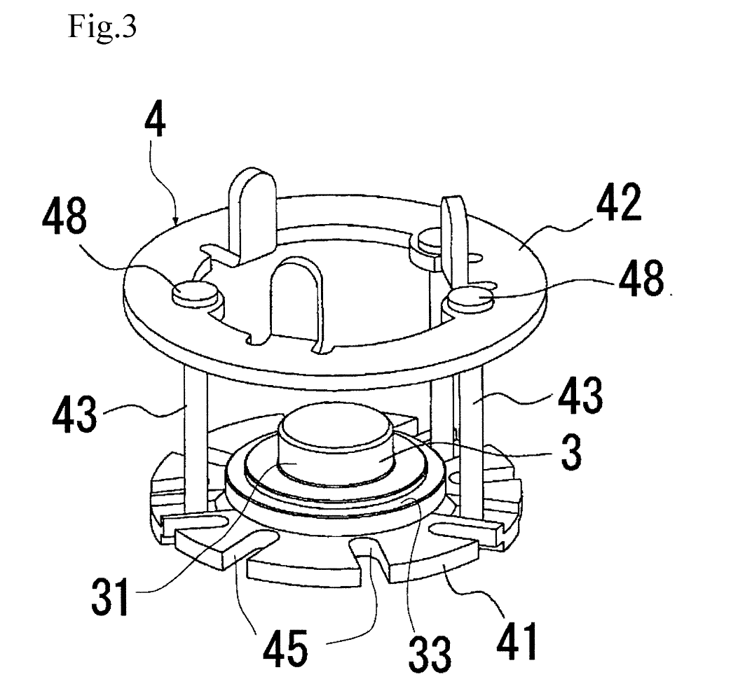

The valve member 3, which has a disc-like shape, is in contact with and thus closes the nozzle end 11a. One side of the valve member 3 that faces the nozzle 11 has a projection 31, which is positioned in the nozzle 11 (see FIGS. 1 and 3). The other side of the valve member 3 that is opposite the projection 31 has a depression 32, in which a set screw 64 to be described below is positioned. Referring to FIG. 3, the valve member 3 is connected to a disc-shaped deflector 41. The deflector 41 is rotatable with respect to the valve member 3.

A fluororesin water-stopping sheet (not illustrated) serving as a sealing member is provided between the valve member 3 and the nozzle end 11a. The water-stopping sheet is pasted on a contact surface 33 of the valve member 3 or the nozzle end 11a. The water-stopping sheet may be replaced with a fluororesin coating layer.

As illustrated in FIG. 3, the sprinkling unit 4 includes the deflector 41, a guide ring 42, and pins 43. The sprinkling unit 4 is positioned in an internal space provided between the inner periphery of the frame 2 and the outer periphery of the nozzle 11 on the outlet side.

The deflector 41 is fitted to the valve member 3, with a cylindrical peripheral wall 34 around the depression 32 of the valve member 3 extending through the center hole of the deflector 41. The deflector 41 has a plurality of slits 45 at the peripheral edge thereof. The sprinkling pattern is determined by the shape of the slits 45. The deflector 41 also has a plurality of holes on the peripheral edge thereof. The pins 43 are fitted in and fixed to the holes, respectively.

The guide ring 42 has a ring shape with an inside diameter that is greater than the outside diameter of the nozzle 11 on the outlet side. The outside diameter of the guide ring 42 is slightly smaller than the inside diameter of the frame 2 and is greater than the inside diameter of the stepped portion 22 of the frame 2. The guide ring 42 is slidable along the inner peripheral surface of the frame 2. When the sprinkler head S is activated, the guide ring 42 is anchored at the stepped portion 22. The guide ring 42 has a plurality of holes through which the pins 43 extend, respectively. The positions of the holes correspond to the positions of the holes of the deflector 41 through which the pins 43 also extends, respectively. A coil spring 49 (see FIG. 1) is provided on the guide ring 42 and urges the guide ring 42 toward the stepped portion 22 of the frame 2.

The pins 43 each have a thin stick-like shape with a collar portion 48 provided at one end thereof. The pins 43, extending through the holes of the deflector 41 and the holes of the guide ring 42, are each inserted from the other end thereof having no collar portion 48 into the guide ring 42 and then into the deflector 41. After the pins 43 are inserted, the other end of each of the pins 43 is fixed to the deflector 41 by caulking. Thus, the guide ring 42 is allowed to slide along the pins 43.

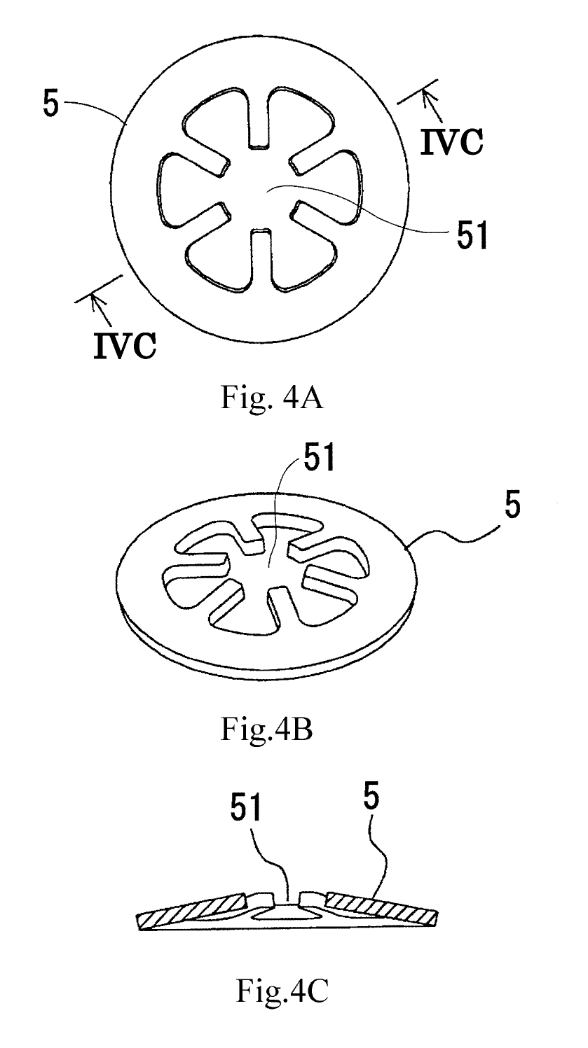

The snapping member 5 is provided between the valve member 3 and the heat-sensitive disassembling unit 6. Referring to FIG. 4, the snapping member 5 has a disc-spring shape with a through hole 51 provided at the center thereof. A head portion of the set screw 64 to be described below is positioned in the through hole 51. A washer 52 is provided on the snapping member 5. With the presence of the washer 52, the load generated by the snapping member 5 is evenly applied to the valve member 3.

Referring to FIG. 1, the heat-sensitive disassembling unit 6 includes the plurality of balls 61, a slider 62, the balancer 63, the set screw 64, a plunger 65, and a cylinder 66.

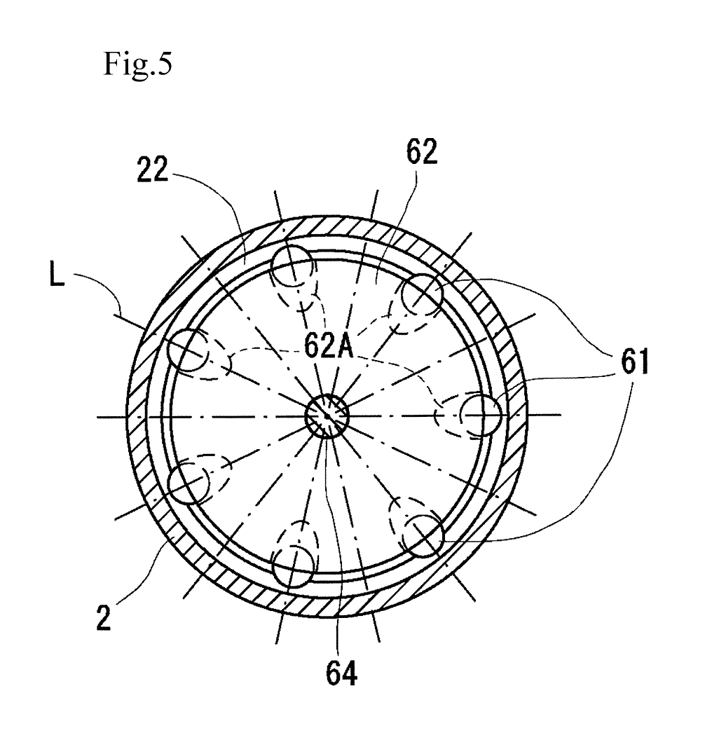

The balls 61 are each a steel spherical member and are of the same size in the present embodiment. While the present embodiment employs seven balls 61, the number of balls 61 is not limited to seven and may be any other odd number such as five or nine. The balls 61 are provided in retaining recesses 62A, respectively, provided at the peripheral edge of the slider 62, which has a disc-like shape (see FIGS. 2 and 5). A lower part of the outer periphery of each of the balls 61 is in contact with the upper inclined surface 23 of the stepped portion 22 of the frame 2, and the slider 62 presses the balls 61 from the upper side. Thus, a force of moving the balls 61 toward the center axis of the sprinkler head S is constantly applied to the balls 61.

The slider 62 has a disc-like shape and has seven retaining recesses 62A, in correspondence with the seven balls 61, at the peripheral edge of a surface thereof that faces the balancer 63, as described above. The retaining recesses 62A are provided at regular intervals in the peripheral direction of the slider 62. Therefore, the load applied to the seven balls 61 is evenly distributed thereamong. Since the load is distributed evenly, the concentration of the load on some particular components is prevented, which further prevents the occurrence of damage to relevant components and the tilting of the slider 62 that may occur with uneven distribution of the load. Hence, the load for closing the nozzle end 11a that is generated by the snapping member 5 provided on the slider 62 is applied to a position at the center of the nozzle 11, that is, evenly over the nozzle end 11a. Consequently, water leakage from the nozzle 11 is prevented.

The balancer 63 has a cylindrical shape with an upper part of the outer periphery thereof positioned on the inner side of the balls 61. The balancer 63 has a stepped portion 63B on a side face thereof, thereby preventing the balls 61 from moving. The slider 62 and the balancer 63 each have a through hole in the center thereof. The through hole of the slider 62 receives a leg portion of the set screw 64. The through hole of the balancer 63 receives the plunger 65.

The set screw 64 includes the head portion and the leg portion. The head portion is positioned in the depression 32 described above and extends through the through hole 51 of the snapping member 5. The head portion of the set screw 64 has a slightly spherical end surface, although not exactly illustrated in the drawings. The leg portion has an external thread 64A at the tip thereof. The leg portion is screwed into the through hole of the slider 62 and meshes with an internal thread portion 65A of the plunger 65 that is threaded on the inner periphery.

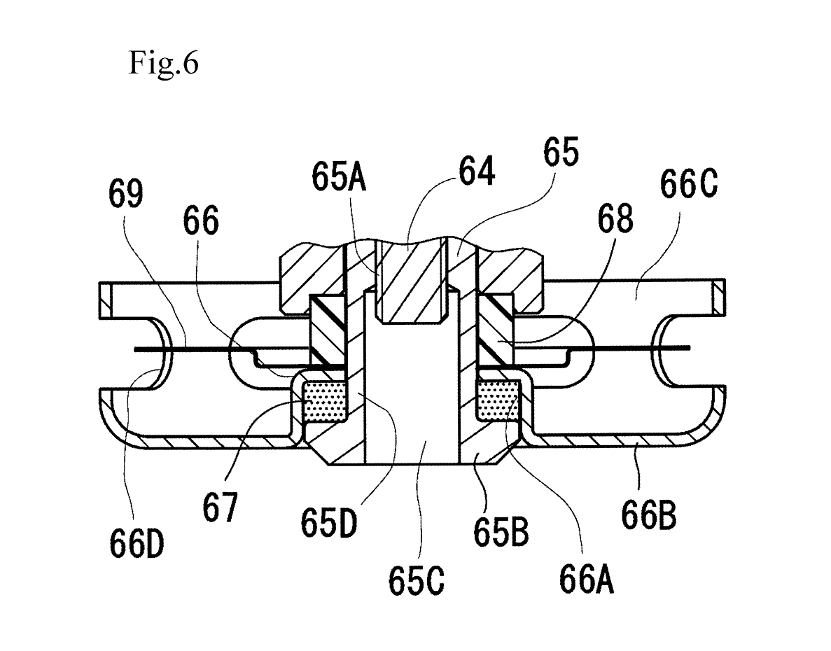

The plunger 65 has a cylindrical shape and includes the internal thread portion 65A at the upper end thereof. The upper end of the plunger 65 projects from the upper end of the balancer 63. Referring to FIG. 6, the plunger 65 includes a collar portion 65B at the lower end thereof. A ring-shaped fusible alloy 67 is placed on the upper surface of the collar portion 65B. The cylinder 66 is provided over the fusible alloy 67.

The plunger 65 has a hole 65C on the inner side of the collar portion 65B. The collar portion 65B extends from the lower end of the plunger 65 up to the internal thread portion 65A. The bore diameter of the hole 65C is greater than the nominal diameter of the internal thread portion 65A. The plunger 65 includes a thin portion 65D whose thickness is defined by the outside diameter of the plunger 65 and the bore diameter of the hole 65C. The cross-sectional area of the thin portion 65D is smaller than that of the internal thread portion 65A and that of the collar portion 65B. Hence, the thin portion 65D has lower thermal conductivity than the internal thread portion 65A and the collar portion 65B. Therefore, heat absorbed by the collar portion 65B is less likely to be transmitted to the internal thread portion 65A. To increase the strength of the thin portion 65D, a resin cap may be fitted in the hole 65C.

The cylinder 66 is made of copper or a copper alloy so that heat absorbed from the surface of the cylinder 66 can be transmitted quickly to the fusible alloy 67. The cylinder 66 has a depression 66A in which the fusible alloy 67 is placed, with a through hole extending through the center of the depression 66A. The plunger 65 extends through the through hole. The cylinder 66 includes a disc portion 66B extending outward from the edge of the depression 66A, and a sidewall portion 66C standing from the outer edge of the disc portion 66B toward the frame 2. The sidewall portion 66C has a plurality of oblong openings 66D, through which the outside air is allowed to reach the outer peripheral surface of the depression 66A. Hence, in case of a fire, heat of the outside air is quickly transmitted to the fusible alloy 67 placed in the depression 66A.

A ring-shaped heat-insulating material 68 is provided between the depression 66A and the lower end of the balancer 63. The heat-insulating material 68 prevents the heat of the fire transmitted to the cylinder 66 from being transmitted to the balancer 63. The hole 65C extends up to a position facing the heat-insulating material 68. Therefore, the heat-insulating effect is further increased.

A disc-shaped heat-sensitive plate 69 is provided between the heat-insulating material 68 and the depression 66A. The heat-sensitive plate 69 is made of copper or a copper alloy so that heat absorbed from the surface thereof can be transmitted quickly to the fusible alloy 67 placed in the depression 66A.

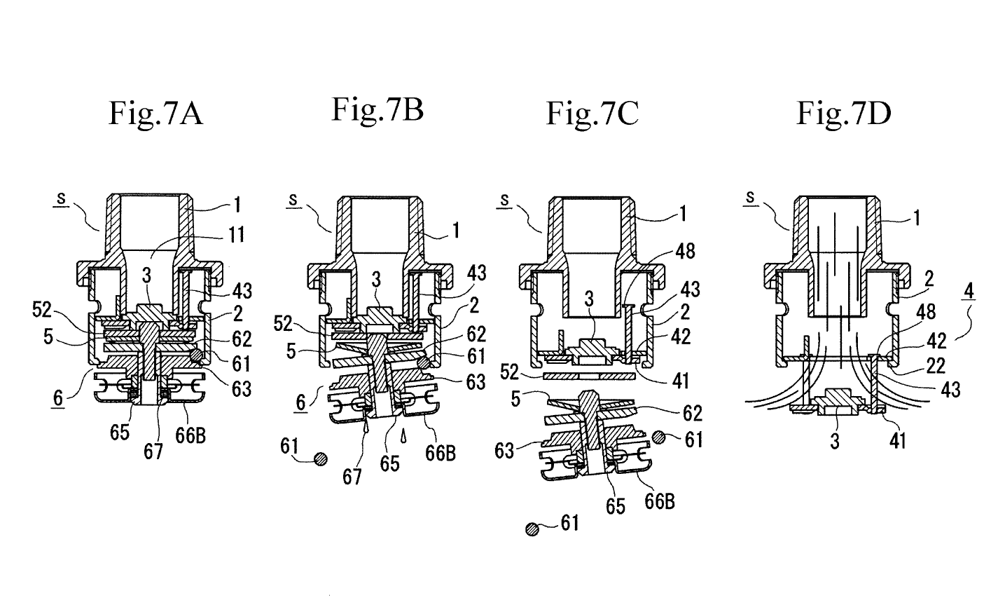

Now, how the sprinkler head S illustrated in FIG. 1 works will be described with reference to FIGS. 7A to 7D. FIGS. 7A to 7D illustrate a process in which the sprinkler head S is activated.

(a) When the sprinkler head S is in a monitoring state, the nozzle 11 of the body 1 is filled with pressurized fire-extinguishing water, and the pressure of the water is applied to the valve member 3 (see FIG. 7A).

(b) If a fire occurs and a hot air current generated by the fire reaches the cylinder 66, the heat of the air current is transmitted to the fusible alloy 67. When the fusible alloy 67 thus heated by the peripheral components starts to melt, the molten fusible alloy 67 is discharged from the gap between the plunger 65 and the depression 66A of the cylinder 66. Consequently, the volume of the fusible alloy 67 is reduced (see FIG. 7B).

When the fusible alloy 67 melts down and is discharged to the outside of the depression 66A, the cylinder 66 is lowered by a length corresponding to the amount of fusible alloy 67 discharged. When the cylinder 66 is lowered, the heat-insulating material 68 and the balancer 63 provided on the cylinder 66 are also lowered (see FIG. 7B).

When the balancer 63 is lowered, the gap between the balancer 63 and the slider 62 is widened. The balls 61 provided near the gap and urged toward the center axis (inward) of the sprinkler head S move away from the upper inclined surface 23 and move inward over the stepped portion 63B of the balancer 63 that is being lowered. In this process, one of the balls 61 is unlocked from the stepped portion 22 of the frame 2. Then, the ball 61 is pushed by the slider 62, quickly passes the vertical part 27, which is short, reaches the guide part 24, which has a greater inside diameter than the vertical part 27, and is released to the outside from the lower end of the stepped portion 22 of the frame 2. With such a movement of one ball 61, the slider 62 is tilted, and the heat-sensitive disassembling unit 6 that has been held loses its balance. Then, the remaining ones of the balls 61 are urged to move by the guide part 24. Thus, the snapping member 5 and the heat-sensitive disassembling unit 6 quickly fall off (see FIG. 7C).

More specifically, referring to FIG. 5, the balls 61 are arranged such that only one ball 61 is positioned on each of the virtual straight lines L (lines extending along the diameter) passing through the center of the slider 62 and the outer peripheral edge of the slider 62. Hence, if one of the balls 61 falls off with the melting of the fusible alloy 67, the slider 62 easily loses its balance. Accordingly, the remaining ones of the balls 61 are urged to move. Consequently, the time taken for the heat-sensitive disassembling unit 6 to fall off is shortened. Thus, the time period from when the fusible alloy 67 starts to melt until when the sprinkler head S is activated is made shorter than in the case of the related-art sprinkler head employing balls 61.

During a period from when the balls 61 start to move away from the stepped portion 22 until when the snapping member 5 and the heat-sensitive disassembling unit 6 are lowered, the valve member 3 on which the snapping member 5 and the washer 52 act is pressed against the nozzle end 11a and continues to close the nozzle 11. That is, the load generated by the snapping member 5 is applied to the valve member 3 through the washer 52, whereby the valve member 3 continues to close the nozzle end 11a until the entirety of the heat-sensitive disassembling unit 6 falls off.

(c) When the snapping member 5 and the heat-sensitive disassembling unit 6 provided below the valve member 3 fall off, the valve member 3 is lowered. With the lowering of the valve member 3, the deflector 41 attached to the valve member 3 and the guide ring 42 and the pins 43 attached to the deflector 41 are lowered. When the pins 43 are lowered, the collar portions 48 at the tops of the pins 43 are anchored at the guide ring 42 while the guide ring 42 is anchored at the stepped portion 22 of the frame 2. Consequently, the valve member 3 and the deflector 41 are hung from the frame 2 with the pins 43.

(d) When the valve member 3 is lowered as described above, the nozzle 11 is opened. Consequently, the pressurized fire-extinguishing water strikes the deflector 41 and is sprinkled in all directions to extinguish the fire (see FIG. 7D).

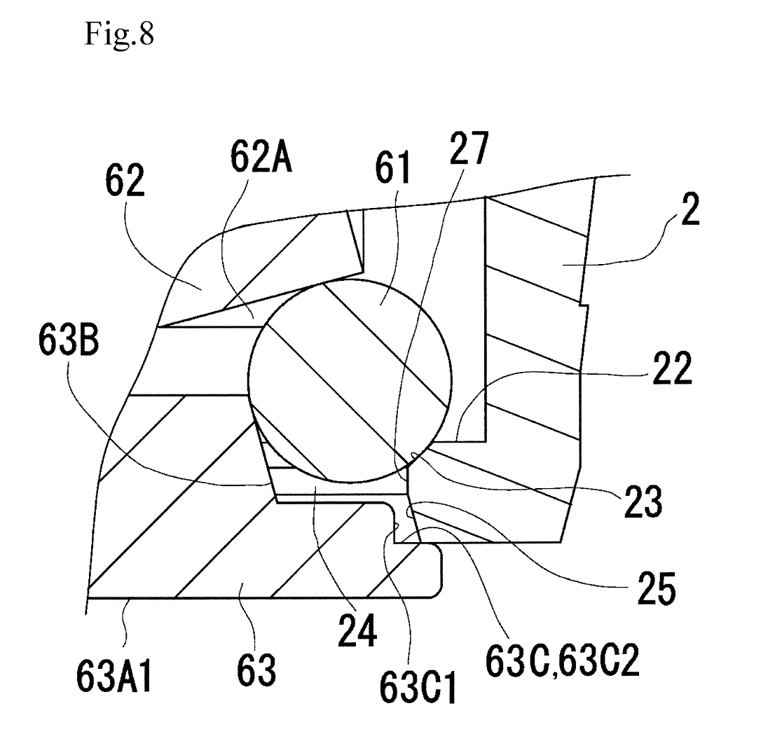

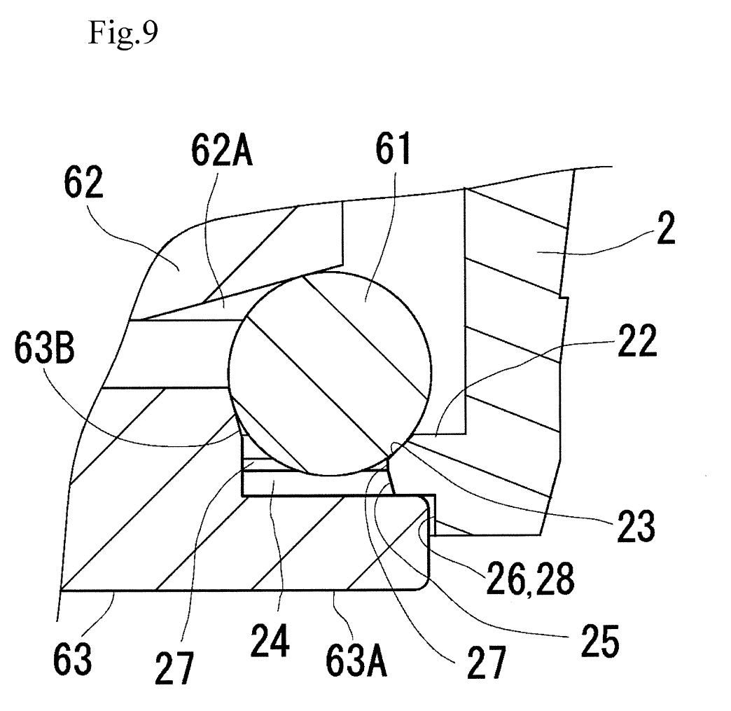

### Modifications of Embodiment (FIGS. 8 and 9)

Modifications of the sprinkler head S according to the above embodiment will now be described.

While the above embodiment employs the guide part 24 illustrated in FIG. 2, the guide part 24 may be modified. For example, in a first modification illustrated in FIG. 8, the guide part 24 includes only the lower inclined surface 25, with no straight part 26. The contact recess 63C of the balancer 63 is positioned on the inner side of the lower inclined surface 25. Such a modification also enhances the shock resistance of the sprinkler head S, as in the embodiment illustrated in FIG. 2. Note that, in the first modification illustrated in FIG. 8, the vertical part 27 of the stepped portion 22 is longer than that of the embodiment illustrated in FIG. 2. Hence, in terms of the quick movement of the balls 61 from the upper inclined surface 23 to the outside of the frame 2, the embodiment illustrated in FIG. 2 is superior to the first modification.

As a second modification, referring to FIG. 9, the guide part 24 may have a contact recess 28 on the lower side of the lower inclined surface 25. Since the stepped portion 22 of the frame 2 according to the second modification has the contact recess 28, the collar portion 63A of the balancer 63 according to the second modification has no contact recess 63C employed in the above embodiment. Moreover, the outer peripheral edge of the collar portion 63A according to the second modification is flat. The contact recess 28 is defined by the straight part 26 and an upper surface (the bottom surface of the stepped portion 22). In such a configuration, as in the case of the embodiment illustrated in FIG. 2, the shock resistance of the sprinkler head S is enhanced. The second modification differs from the embodiment illustrated in FIG. 2 and from the first modification illustrated in FIG. 8 in that the length of the lower inclined surface 25 in the axial direction of the sprinkler head S is short and in that no part below the lower inclined surface 25 comes into contact with the balls 61 because a space as the contact recess 28 is provided below the lower inclined surface 25. In the second modification illustrated in FIG. 9 that has such differences, the length by which the frame 2 is expected to come into contact with the balls 61 in the axial direction thereof is the shortest among the embodiment and the two modifications thereof. Hence, the sprinkler head S according to the second modification is activated most quickly.

What is claimed is:

1. A sprinkler head comprising:
a body having a nozzle;
a valve member that closes an outlet of the nozzle;
a tubular frame whose one end is connected to the body and the other end has a stepped portion projecting inward; and
a heat-sensitive disassembling unit including a plurality of balls locked at the stepped portion, the heat-sensitive disassembling unit being disassembled and activated when a fusible alloy melts,
wherein the stepped portion includes
a contact part provided at an inner-peripheral upper edge of the stepped portion and with which the balls are in contact; and
a guide part provided by cutting off an inner-peripheral lower edge of the stepped portion, the guide part allowing any of the balls that is displaced from the contact part to move downward from the stepped portion.

2. The sprinkler head according to claim 1, wherein the contact part is an upper inclined surface provided at the inner-peripheral upper edge.

3. The sprinkler head according to claim 1, wherein the guide part has a lower inclined surface provided at the inner-peripheral lower edge.

4. The sprinkler head according to claim 1, wherein the guide part includes an inner-peripheral stepped part provided at the inner-peripheral lower edge.

5. The sprinkler head according to claim 1, wherein the stepped portion includes a vertical part provided between the contact part and the guide part and whose length in a direction in which a center axis of the frame extends is shorter than a thickness of the stepped portion.

6. The sprinkler head according to claim 1,
wherein the heat-sensitive disassembling unit includes a balancer provided between the fusible alloy and the balls, and
wherein the balancer has a contact recess at an outer periphery, the contact recess being in contact with the stepped portion of the frame.

7. The sprinkler head according to claim 1,
wherein the heat-sensitive disassembling unit includes a slider that retains the balls at respective predetermined positions of the stepped portion, and
wherein the balls are each retained on a corresponding one of different virtual straight lines each passing through a center of the slider and an outer peripheral edge of the slider.

8. The sprinkler head according to claim 7, wherein the slider has retaining recesses at the outer peripheral edge, the retaining recesses receiving the balls, respectively.

9. The sprinkler head according to claim 8, wherein the retaining recesses are provided in an odd number and are arranged at regular intervals on one virtual circular line.
